(19) United States
(12) Patent Application Publication
(10) Pub. No.: US 2025/0293893 A1
(43) Pub. Date: Sep. 18, 2025

(54) SECURELY PAIRING A COMPUTING DEVICE WITH PERIPHERALS OF A TERMINAL DEVICE

(71) Applicant: Target Brands, Inc., Minneapolis, MN (US)

(72) Inventors: Arnab Pal, Rogers, MN (US); Adam Nawrocki, Plymouth, MN (US); Bernadette M. Dehnert, Coon Rapids, MN (US); Elisa Clark, Bloomington, MN (US); Lijuan Zhang, Coon Rapids, MN (US); Richard Ryan Walstrom, Champlin, MN (US); Robert M. Renkor, Bloomington, MN (US); David Pankratz, Minneapolis, MN (US); Dylan Essing, Minneapolis, MN (US)

(21) Appl. No.: 18/602,397

(22) Filed: Mar. 12, 2024

(51) Int. Cl. H04L 9/32; H04L 9/40

(52) U.S. Cl. CPC H04L 9/3268; H04L 63/0428

(57) ABSTRACT

In some implementations, a computer system for securely pairing a computing device with peripherals of a terminal device can include the computing device, the terminal device, and a facility server. The terminal device can output connection information that identifies the terminal device, and the computing device can detect the connection information. A trust negotiation protocol can be performed between the computing device, the terminal device, and the facility server to establish a secure connection between the computing device and the terminal device. The terminal device can receive, from the computing device over the secure connection, a request to access one or more peripherals of the terminal device, and a temporary pairing can be established between the computing device and the one or more peripherals of the terminal device.

### TECHNICAL FIELD

This specification generally relates to techniques for securely pairing one or more computing devices with peripherals of a terminal device, for example, using a certificate-based trust negotiation protocol.

### BACKGROUND

Point of sale (POS) systems are generally used in physical retail stores to facilitate customer transactions. POS systems can include POS terminals, such as customer-operated terminals and employee-operated terminals, which can interface with multiple different components to scan products and process transactions. For example, a POS system can include a product scanner to identify products (e.g., a barcode scanner, a QR code scanner), a payment terminal for accepting payment (e.g., a credit card reader), a display to present information about scanned products and transactions, and a conveyor system to hold and transport products as part of the checkout process (e.g., a conveyor belt holding and conveying products that are yet to be scanned during a checkout process). The POS terminal can compile transaction information and communicate with the payment terminal to complete a transaction.

POS terminals can be provided in stationary and mobile configurations. A stationary POS terminal can be a POS terminal that is affixed to a structure, such as the floor or a wall, or that is otherwise not readily movable or portable by a user. Such stationary POS terminals can include, for example, self-checkout POS terminals and employee-operated POS terminals organized with adjacent checkout lanes. A stationary POS terminal can incorporate various peripheral devices, software, and services, such as displays, payment card readers, scales, scanners, and printers. A mobile POS device can be a handheld device with an integrated display and payment card reader, but may lack other peripheral devices of the stationary POS terminal. Both the stationary POS terminal and the mobile POS device can communicate with backend server systems to access transaction services.

### SUMMARY

This document generally describes computer systems, processes, program products, and devices for securely pairing one or more computing devices, such as mobile point of sale (POS) devices and/or stationary POS devices, with peripherals of a terminal device, such as a stationary POS terminal device. In general, some computing devices used for generating transaction data (e.g., collecting data that pertains to a list of items to be included in a retail transaction, collecting data for an inventory operation, etc.) may be suitable for simple transactions, however the devices may lack specialized hardware for collecting particular types of data, and/or for processing particular transactions. For example, some computing devices may lack scales for weighing items that are sold by weight, printers for printing a physical record of a transaction, payment terminals for processing particular types of payment (e.g., cash transactions), and so forth. To build and process transactions that involve such factors, for example, a computing device can be temporarily paired with a terminal device that includes peripherals that can be leveraged by the computing device. For example, the computing device can begin building a transaction without being paired with a terminal device (e.g., by adding item data to an in-process transaction), and can then be paired with the terminal device to continue building the transaction (e.g., by adding additional item data through the use of one or more peripherals of the terminal device), and/or to finalize the transaction. By leveraging the technology described in this document, for example, hardware resources (e.g., peripherals of the terminal device) can be shared among multiple different computing devices over time (e.g., either sequentially or concurrently), thus conserving the hardware resources and available space.

In general, the technology described in this document can use a certificate-based trust negotiation protocol to securely pair computing devices (e.g., mobile devices and/or stationary devices) with terminal devices and their associated peripherals. To facilitate pairing operations, for example, a terminal device can generate and output connection information (e.g., a visually displayed code, or a code that is presented in a non-visual manner, such as an audio signal, a wireless signal, etc.). A user who intends to pair their computing device with peripherals of the terminal device can use their computing device to detect the connection information (e.g., by scanning the code). After the connection information has been detected by the computing device, for example, a certificate-based trust negotiation protocol can be initiated between the computing device and the terminal device to establish a trusted secure connection between the devices. After the certificate-based trust negotiation protocol is complete, and the certificate connection has been established, the terminal device can route commands from the computing device to a paired peripheral of the terminal device, and/or can route data from the peripheral to the computing device. The terminal device, for example, can maintain data that tracks pairings between computing devices and peripherals, and can use the data to facilitate correct data routing to maintain the integrity and security of ongoing transactions.

In some implementations, a computer system for securely pairing a computing device with peripherals of a terminal device can include the computing device, the terminal device, and a facility server. The computing device can include a wireless communication interface. The terminal device can include a wired communication interface and a wireless communication interface. The peripheral devices of the terminal device can each be configured to communicate with the terminal device using the wired communication interface of the terminal device. The computing device, the terminal device, and the facility sever can each include one or more processors, memory, and storage devices storing respective instructions that, when executed, cause the respective computing device, terminal device, and session server to perform operations including: outputting, by the terminal device, connection information that identifies the terminal device; detecting, by the computing device, the connection information that has been output by the terminal device; in response to detecting the connection information, transmitting, by the computing device using its wireless communication interface and for receipt by the terminal device, a trust negotiation initiation message; after the trust negotiation initiation message has been transmitted, performing a trust negotiation protocol between the computing device, the terminal device, and the facility server to establish a secure connection between the computing device and the terminal device; receiving, by the terminal device using its wireless communication interface and from the computing device over the secure connection, a request to access one or more peripherals of the terminal device; and in response to receiving the request to access the one or more peripherals of the terminal device, establishing, by the terminal device, a temporary pairing between the computing device and the one or more peripherals of the terminal device.

Other implementations of this aspect include corresponding computer methods, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The computing device, the terminal device, and the facility server can be included in a local network of a facility, with the computing device being a mobile computing device having a wireless connection to the local network of the facility, and with the terminal device and the facility server each having respective wired connections to the local network. The one or more peripherals can only have a wired connection to the terminal device and not be directly connected to the local network. The connection information that identifies the terminal device can correspond to an address of the terminal device on the local network. Outputting the connection information that identifies the terminal device can be performed by the terminal device when a user is actively logged into the terminal device, and in response to the launching of a pairing application on the terminal device. The connection information that identifies the terminal device can be visually output by a display of the terminal device, and detecting the connection information by the computing device can include performing a scan of the connection information using scanning hardware of the computing device. The connection information that identifies the terminal device can be output by the terminal device in a non-visual manner, and detecting the connection information by the computing device can include using non-visual detection hardware of the computing device to detect the connection information. The trust negotiation protocol between the computing device, the terminal device, and the facility server can include: in response to receiving the trust negotiation initiation message, transmitting, by the terminal device, a terminal device certificate for receipt by the computing device; after receiving the terminal device certificate, validating the terminal device certificate, by the computing device and based on terminal device certificate validation data provided by a certificate authority of the facility server; in response to validating the terminal device certificate, transmitting, by the computing device, a computing device certificate for receipt by the terminal device; and after receiving the computing device certificate, validating the computing device certificate, by the terminal device and based on computing device certificate validation data provided by the certificate authority of the facility server. The request to access one or more peripherals of the terminal device can be a request to access all peripherals of the terminal device. The request to access one or more peripherals of the terminal device can be a request to access a particular one of the peripherals of the terminal device. The request to access one or more peripherals of the terminal device can be transmitted, by the computing device and for receipt by the terminal device over the secure connection. The request to access the one or more peripherals can be initiated by a transaction building and processing application running on the computing device. The terminal device can determine whether the one or more peripherals of the terminal device are currently paired with another computing device. The terminal device can establishe the temporary pairing between the computing device and the one or more peripherals of the terminal device when the one or more peripherals of the terminal device are not currently paired. The terminal device can determine whether a particular peripheral of the one or more peripherals of the terminal device is associated with a one-to-one pairing relationship or a one-to-many pairing relationship. The terminal device can establish the temporary pairing between the computing device and the particular peripheral when the particular peripheral is associated with a one-to-many pairing relationship. The terminal device can receive from another computing device over another secure connection between the other computing device and the terminal device, another request to access the particular peripheral that is associated with the one-to-many pairing relationship, and in response to receiving the other request, can concurrently establish another temporary pairing between the other computing device and the particular peripheral. After establishing the temporary pairing between the computing device and the one or more peripherals of the terminal device, the terminal device can receive a peripheral device command for a particular peripheral of the one or more peripherals of the terminal device from the computing device, and can route the peripheral device command to the particular peripheral. After establishing the temporary pairing between the computing device and the one or more peripherals of the terminal device, the terminal device can receive peripheral data generated by the peripheral from the peripheral, and can route the peripheral data to the computing device. After establishing the temporary pairing between the computing device and the one or more peripherals of the terminal device, a record of the established pairing can be maintained at a datastore of the terminal device. The terminal device can receive a request to reclaim the one or more peripherals of the terminal device from a terminal device application, and in response to receiving the request to reclaim the one or more peripherals of the terminal device, can terminate the temporary pairing that has been established between the computing device and the one or more peripherals of the terminal device. The terminal device can receive a command to release the one or more peripherals of the terminal device from the computing device, and in response to receiving the command to release the one or more peripherals of the terminal device, can terminate the temporary pairing that has been established between the computing device and the one or more peripherals of the terminal device. The terminal device can determine that a timeout condition has occurred for a particular peripheral of the one or more peripherals of the terminal device, and in response to determining that the timeout condition has occurred, can terminate the temporary pairing that has been established between the computing device and the particular peripheral of the terminal device.

The systems, devices, program products, and processes described throughout this document can, in some instances, provide one or more of the following advantages. A secure pairing process can provide a computing device with access to one or more peripherals of a terminal device, to extend the functionality of the computing device, and to facilitate the completion of transactions that cannot normally be performed by the computing device. A terminal device can employ a USB hub connection (and/or other wired connections) for various peripherals, thus simplifying the setup and configuration of peripherals at the terminal device. Also, as the peripherals may not be directly connected to any network, the network connection of the terminal device and its existing security protocols can be leveraged, thus maintaining security with respect to functions of the peripherals. The status of issued certificates can be maintained and updated through device management practices, thereby improving system security. By using a private certificate authority, communication overhead can be reduced when validating device certificates, and security can be improved. Multiple computing devices can be concurrently or sequentially paired with a single terminal device, thus facilitating the sharing and conservation of hardware resources, and reducing an amount of space consumed by such resources.

Other features, aspects and potential advantages will be apparent from the accompanying description and figures.

### DESCRIPTION OF DRAWINGS

FIG. 1 depicts an example system including a terminal device, peripherals of the terminal device, a computing device, and a facility server.

FIGS. 2A-2E depict an example illustrative process for securely pairing a computing device with peripherals of a terminal device.

FIG. 3 depicts an example certificate-based trust negotiation protocol for establishing trust between a computing device and a terminal device.

FIG. 4 is a conceptual diagram of example established pairings between computing devices and terminal device peripherals.

FIG. 5A is a flow diagram of an example technique for routing commands from a computing device to a paired terminal device peripheral.

FIG. 5B is a flow diagram of an example technique for routing data from a terminal device peripheral to a paired computing device.

FIG. 6 is a schematic diagram that shows an example of a computing device and a mobile computing device.

Like reference symbols in the various drawings indicate like elements.

### DETAILED DESCRIPTION

This document describes technology that can securely pair one or more computing devices (mobile devices and/or stationary devices) with one or more peripherals of a terminal device, using a certificate-based trust negotiation protocol. In a secure pairing operation that is facilitated by the presently described technology, a terminal device can generate and output connection information (e.g., a code), and a user who intends to pair their personal computing device with peripherals of the terminal device can use their computing device to detect the connection information. Upon detecting the connection information, a certificate-based trust negotiation protocol can be initiated between the computing device and the terminal device to establish a trusted secure connection between the devices. After the connection has been established, the terminal device can route commands from the computing device to a paired peripheral of the terminal device, and/or can route data from the peripheral to the computing device.

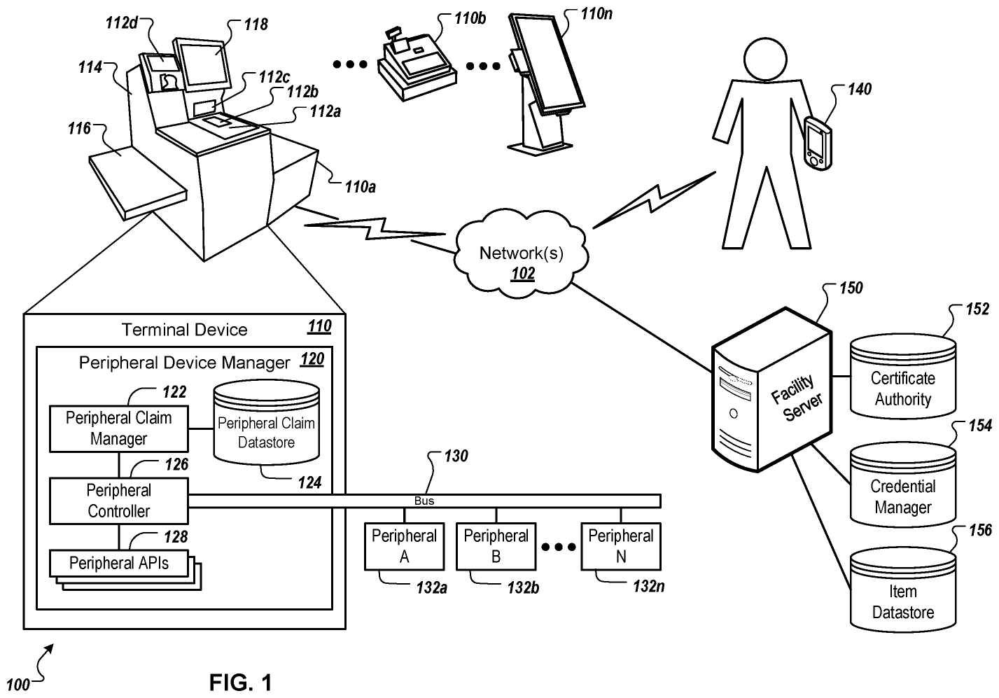

FIG. 1 depicts an example system 100 including a terminal device 110 (e.g., one of the example terminal devices 110a-n), peripherals (e.g., peripherals 112a-d, 132a-n) of the terminal device 110, a stationary or mobile computing device (e.g., mobile device 140), and a facility server 150. Communication between the terminal device 110, the mobile device 140, and the facility server 150 can occur over one or more communications networks 102, including a LAN (local area network), a WAN (wide area network) and/or the Internet. Each of the terminal device 110, the mobile device 140, and the facility server 150 can connect to the network(s) 102 using a wired or a wireless connection. In some implementations, the mobile device 140 can connect to the network(s) 102 using a wireless connection, whereas the facility server 150 and the terminal device 110 can each connect to the network(s) 102 using a wired connection (e.g., with the terminal device 110 and/or the facility server 150 having the capability to occasionally use a backup wireless connection). In some implementations, the terminal device 110 and the mobile device 140 can communicate directly using a short-range wireless technology (e.g., Wi-Fi, Bluetooth, near-field communication (NFC), etc.).

The terminal device 110, for example, can represent a stationary computing device that includes one or more processors, memory, and data storage devices. In some examples, the terminal device 110 can represent a point of sale (POS) device (e.g., POS device 110a), a register device (e.g., checkout register 110b), a kiosk device (e.g., kiosk 110n), or another sort of device that facilitates the exchange of information and/or the performance of transactions. The terminal device 110, for example, can include and/or communicate with one or more input devices (e.g., touchscreens, keypads, pointers, data collection devices, etc.) and one or more output devices (e.g., displays, speakers, printers, etc.), which are also referred to throughout this document as “peripheral devices” of the terminal device (e.g., peripherals 112a-d, 132a-n). In the present example, the terminal device 110 can also include various hardware and/or software components, including a peripheral device manager 120, that can control access to and functionality of the peripherals 112a-d, 132a-n. The peripheral device manager 110, for example, can include a peripheral claim manager 122 (e.g., including software and/or hardware components) that can manage peripheral claims from various mobile devices 140, and a peripheral claim datastore 124 that maintains data associated with the claims. The peripheral device manager 110, for example, can also include a peripheral controller 126 (e.g., including software and/or hardware components) that is configured to send commands and other data to the peripherals 132a-n, and to receive data from the peripherals 132a-n, via a system bus 130. In some examples, the bus 130 can provide a wired connection (e.g., a Universal Serial Bus (USB) hub connection, or another suitable wired connection) between the peripheral controller 126 of the terminal device 110 and the peripherals 132a-n. A USB hub connection, for example, can include a shared power source (e.g., 12V, 24V, or another suitable voltage) and shared connectivity for the peripherals 132a-n, thus simplifying the setup and configuration of peripherals at the terminal device 110. Also, as the peripherals 132a-n in the present example are not directly connected to the network(s) 160 (e.g., the peripherals 132a-n only having a wired connection to the terminal device 110), the network connection of the terminal device 110 and its existing security protocols can be leveraged, thus ensuring improved security in the system 100 regarding access to the peripherals 132a-n.

In some implementations, peripheral access and functionality can be provided using an application programming interface (API) framework. For example, the peripheral device manager 120 can include multiple peripheral APIs 128, with each peripheral API being configured to provide an interface to a respective peripheral. In the present example, a first peripheral API can be configured to provide an interface to peripheral 132a (e.g., Peripheral A), a second peripheral API can be configured to provide an interface to peripheral 132b (e.g., Peripheral B), a third peripheral API can be configured to provide an interface to peripheral 132n (e.g., Peripheral N), and so forth. To interact with a particular peripheral (e.g., to send commands and other data to the peripheral, and/or to receive data from the peripheral), for example, application code (e.g., code being executed by the terminal device 110 or the mobile device 140) can reference the API of the peripheral, which can in turn interface with the peripheral via the peripheral controller 126 and the bus 130. In some examples, application code of a device application can be developed within a microservice-based web framework that can provide the application with access to the peripherals 132a-n. The device application, for example, can include general control logic and user interfaces, and can access the peripherals 132a-n as specified by the control logic, through the peripheral APIs 128 of the web framework.

In some implementations, a terminal device can be configured as a point of sale (POS) device, such as a checkout device used in a retail environment. In the present example, the terminal device 110 (e.g., a POS device) can include multiple components, including a display 118 (e.g., a touchscreen display, or a non-touchscreen display combined with a user input device, such as a keypad or voice interface), a terminal housing 114 to which and/or within which the various components are mounted, and one or more item placement areas 116 (e.g., for placing and bagging products during a checkout process). Peripherals 112a-d (e.g., similar to the conceptually represented peripherals 132a-n) of the POS terminal device 110, for example, can include a scale 112a for weighing items during a checkout process, a scanner 112b for scanning the items (e.g., using barcodes, radio frequency tags, etc.), a printer 112c for printing a receipt of a sale, and a payment terminal 112d for processing a customer's form of payment (e.g., a credit card, a gift card, etc.). Other types of peripherals may also be included in the terminal housing 114 of the POS terminal device 110, such as a cash drawer, additional data collection devices (e.g., an additional scanner, a camera, etc.), and/or additional output devices (e.g., potentially including the display 118, speakers, etc.).

The mobile device 140, for example, can represent various forms of mobile processing devices, including but not limited to a tablet computer, a personal digital assistant (PDA), a smartphone, or another sort of processing device. For example, the mobile device 140 can include one or more input devices (e.g., touchscreens, keypads, pointers, scanners, etc.) and one or more output devices (e.g., display units, audio speakers, haptic feedback mechanisms, etc.). The mobile device 140, for example, can also include various hardware and/or software components for executing computer applications. In some examples, the mobile device 140 can be one of a collection of specialized and similarly configured devices, with each device including a display, a code detection unit (e.g., an optical detection unit such as a camera, a laser scanner, etc., and/or a wireless signal detection unit), and one or more wireless communication components (e.g., Wi-Fi, Bluetooth, near-field communication (NFC), etc.). Multiple different users (e.g., workers, employees, etc.), for example, can each be issued a respective mobile device 140, and each user can employ applications executed by the device to perform functions for the organization (e.g., after logging into their respective mobile device).

Although the present example includes mobile device 140 (a type of computing device), in other examples, device 140 can be a stationary computing device (e.g., a stationary POS device). In such alternate examples, one or more computing devices (e.g., including mobile computing devices and/or stationary computing devices) can be paired with peripherals of the terminal device 110. For example, the peripherals of the terminal device 110 can include equipment that is configured to be shared among multiple mobile and/or stationary POS devices, such as a payment station, a printer, or another sort of equipment. The terminal device 110, its shared peripherals, and one or more paired computing devices (e.g., mobile and/or stationary POS devices), for example, can form a device cluster, thereby conserving space and equipment in a retail environment.

The facility server 150, for example, can represent various forms of computing servers, including but not limited to network servers, web servers, application servers, or other suitable computing servers, and can include one or more computing server devices. In some implementations, operations of the facility server 150 can be performed by a single computing server device (or a group of connected computing server devices). In some implementations, operations of the facility server 150 can be distributed among one or more additional computing server devices/systems. In general, the facility server 150 can be configured to provide application, login, and security services to terminal devices (e.g., terminal device 110) and mobile devices (e.g., mobile device 140) located in a facility (e.g., a store, a warehouse, or another sort of facility). To provide such services, for example, the facility server 150 can execute computer code, and can include and/or communicate with one or more data sources (e.g., including databases, file-based data sources, cached data sources, etc.). In the present example, data sources included in and/or accessible by the facility server 150 can include a certificate authority 152 (e.g., for providing and/or validating device certificates to facilitate trust between devices in the system 100), a credential manager 154 (e.g., for facilitating user logins of devices and providing access to computing services in the system 100), and an item datastore 156 (e.g., for maintaining and providing data related to items in the facility). In some implementations, at least some functions that are provided by the applications running on the terminal device 110 and/or the mobile device 140 can be executed by the facility server 150. For example, the facility server 150 can provide backend services (e.g., accessible through APIs) that are configured to provide data (e.g., item data, payment data, etc.) and transaction capabilities to terminal and/or mobile device applications.

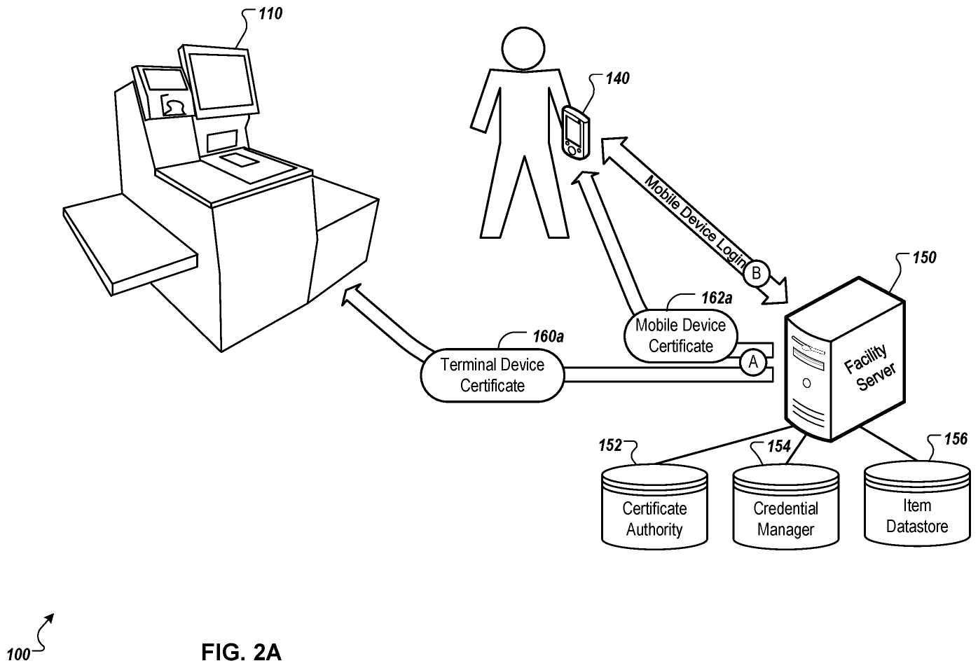

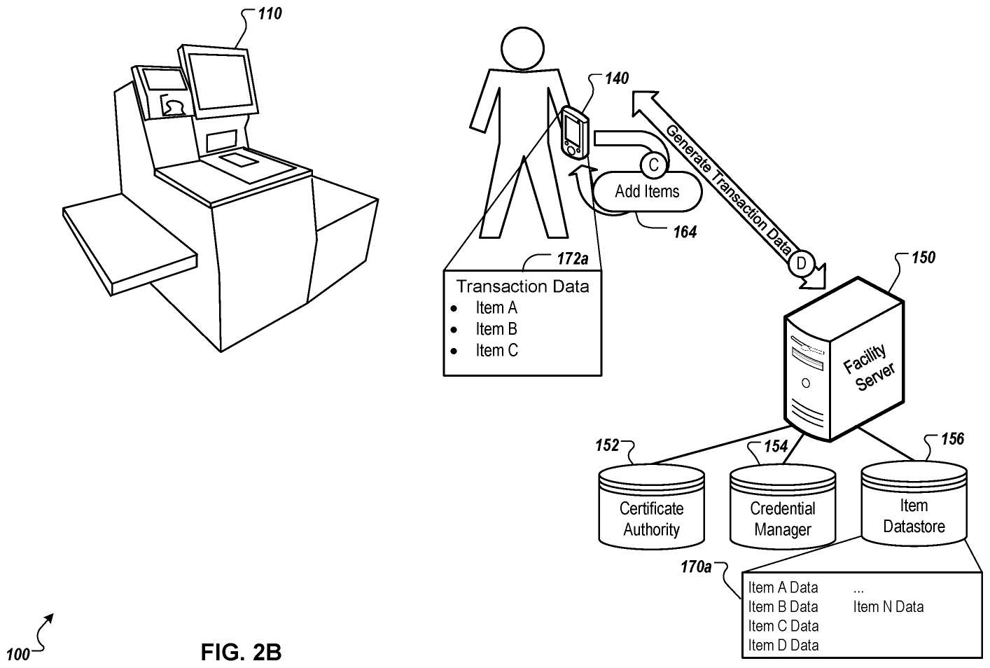

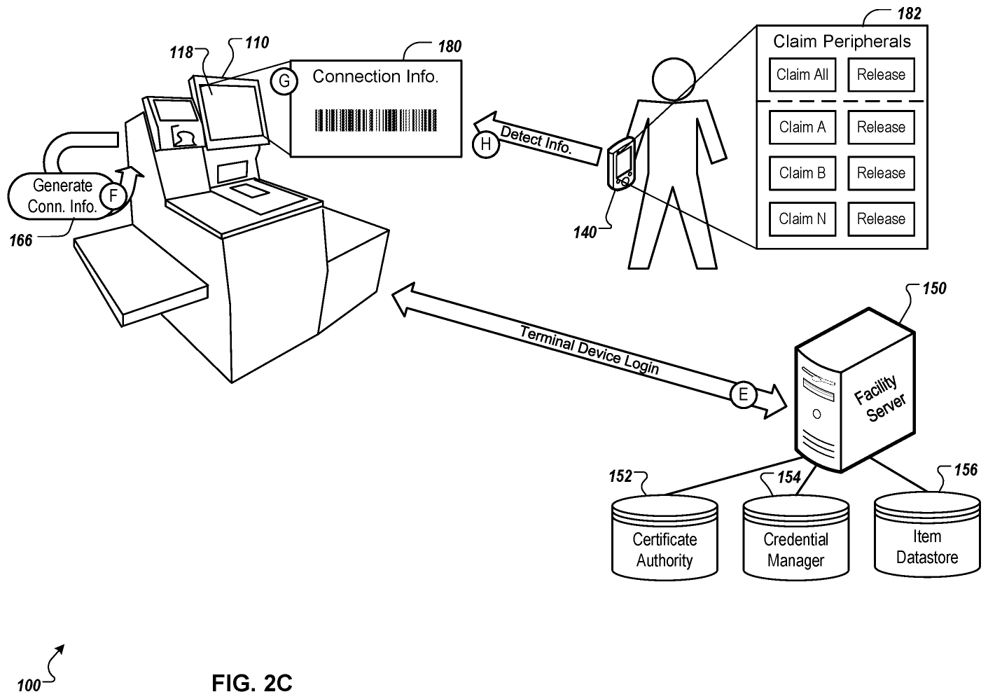

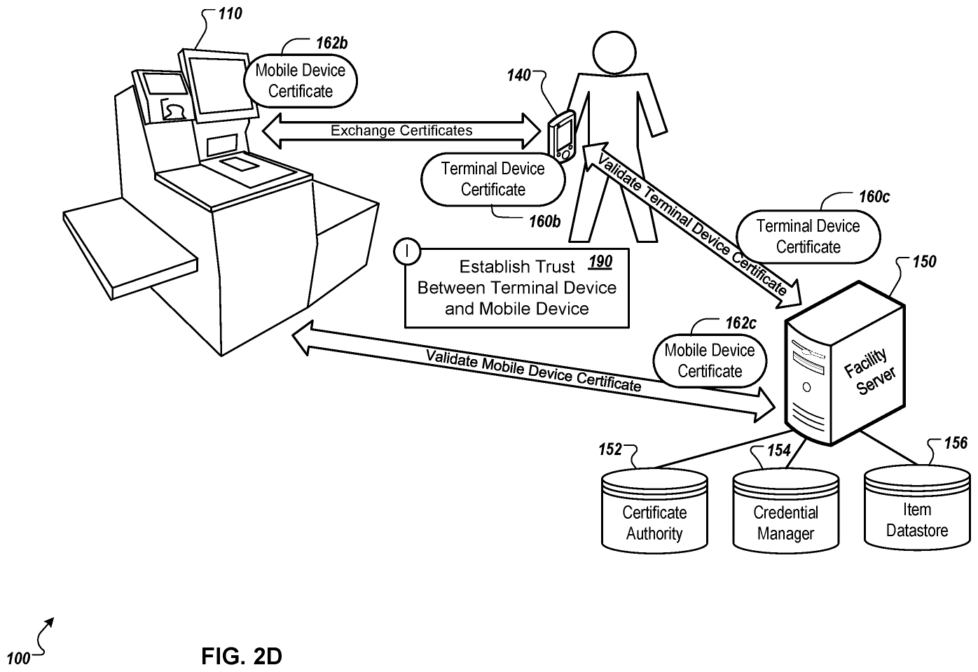

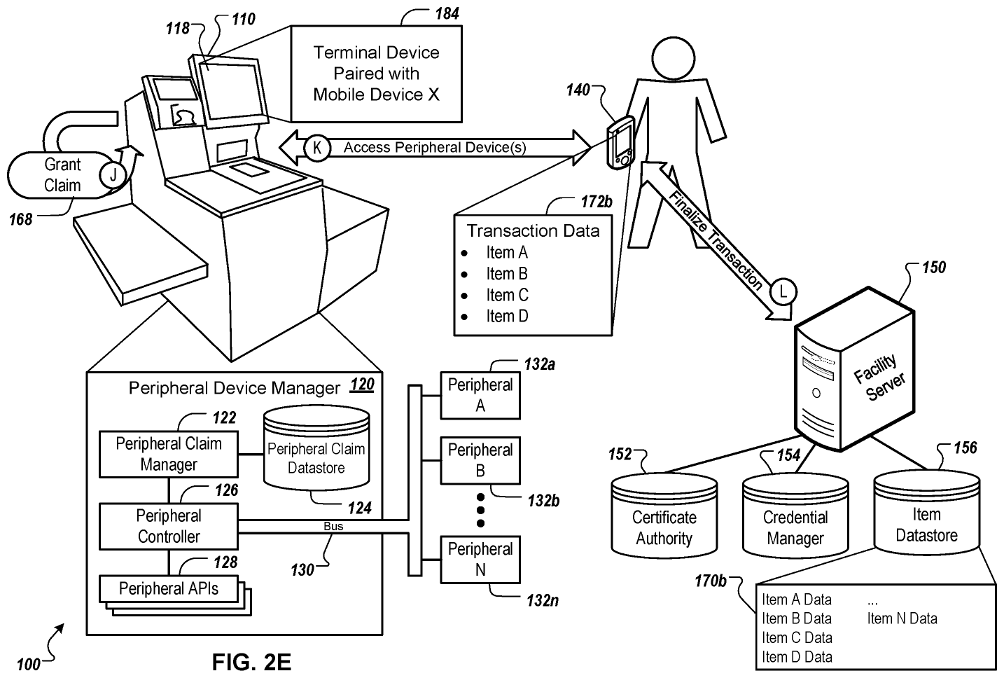

FIGS. 2A-2E depict an example illustrative process for securely pairing a computing device with peripherals of a terminal device, which is described herein as being performed by the example system 100 (shown in FIG. 1). As part of this example illustrative process, the terminal device 110 is depicted as an example point of sale (POS) device, however the process depicted in FIGS. 2A-2E can be applied to and performed by other terminal devices as described throughout this document. Further, as part of this example illustrative process, the device 140 is described as a mobile computing device, however the process depicted in FIGS. 2A-E can be applied to stationary and/or mobile computing devices. In the present example, the illustrative process is shown in stages (A) to (L), which may occur in the illustrated sequence, or which may occur in a sequence that is different than in the illustrated sequence. In some examples, two or more stages (A) to (L) may be concurrent.

Referring now to FIG. 2A, during stage (A), the terminal device 110 and a computing device (e.g., the mobile device 140) each receive respective certificates from the facility server 150, with the terminal device 110 receiving a terminal device certificate 160a, and with the mobile device 140 receiving a mobile device certificate 162a. Each of the certificates 160a, 160b, for example, can be generated, maintained, and provided by the certificate authority 152. The certificate authority 152, for example, can be a trusted entity that is configured to maintain, verify, and issue certificates (e.g., data files used to cryptographically link a device or another entity with a public key).

In some implementations, providing a certificate to a device (e.g., a terminal device or a mobile device) can occur as part of a process for registering the device as a trusted device, with a device management system (not shown) of the facility server 150. When registering the device, for example, the facility server 150 can maintain data that pertains to the certificate that has been provided to the device, in association with a device identifier (e.g., a Media Access Control (MAC) address, a host name, or another sort of device identifier), and possibly other relevant information (e.g., a date/timestamp indicating when registration occurred, a username of a user who performed the registration, etc.). In general, device registration can be performed when preparing a device for use, such as after performing a software build on a device, after servicing the device, when issuing the device to a user, or at another suitable time.

In some implementations, a status of issued certificates can be maintained and updated over time. The device management system of the facility server 150, for example, can be configured to communicate with the certificate authority 152 with respect to a current status of issued certificates, which can be updated based on events that may occur in the system 100. For example, if a mobile device 140 were to be misplaced in a facility and out of the possession of its user, the device management system of the facility server 150 may instruct the certificate authority 152 to revoke the certificate of the mobile device 140. As another example, if the terminal device 110 were to be serviced (e.g., a repair or replacement of a peripheral of the device 110, an updating of a processor of the device 110, or another sort of service having been performed), the device management system of the facility server 150 may instruct the certificate authority 152 to revoke the certificate of the terminal device 110. As another example, mobile device certificates and terminal device certificates can be set to expire after a specified amount of time has elapsed. By appropriately maintaining and updating the status of issued certificates, for example, access to active certificates can be controlled, thereby improving security in the system 100.

During stage (B), the mobile device 140 can perform a login process with the facility server 150. For example, the mobile device 140 can provide a login interface (not shown) at its display, through which a device user can provide their login credentials (e.g., a user name and password, a personal identification number (PIN), etc.). Providing login credentials, for example, can be accomplished through manual data entry (e.g., interacting with a keypad and/or microphone), use of a scanning hardware of the mobile device 140 (e.g., a code scanner, a biometric scanner, etc.), or another suitable data entry technique. Upon receiving the user's login credentials from the mobile device 140, for example, the facility server 150 can determine whether the received login credentials are valid (e.g., by comparing the received login credentials with stored login credentials available from the credential manager 154).

In some implementations, an access token can be provided to an authenticated device. After the user's login credentials have been authenticated as being valid, for example, an access token can be provided to the device from which the user's login credentials have been received. In the present example, the facility server 150 can provide an access token (not shown) to the mobile device 140 after the user logs in to the server 150. In general, the access token can include data related to the logged-in user of the mobile device 140 (e.g., including permissions, groups, expirations, etc.), and can be used to verify and provide user access rights to various resources in the system 100 (e.g., including application-level and/or function-level features of the mobile device 140, the facility server 150, and/or the terminal device 110). For example, the mobile device 140 can use the access token to enable/disable features of the device 140, and/or to call application programming interfaces (APIs) included in device applications. The access token, for example, can be stored by the mobile device 140 (e.g., in local memory), can be removed when the device user is logged out, and can be replaced after each successful login.

Referring now to FIG. 2B, the logged-in mobile device 140 can be used within the facility to perform various functions and to generate transaction data. For example, a user of the mobile device 140 can generate a list of items (e.g., sometimes referred to as “building a basket” that pertains to a selection of products in a store and/or warehouse) to prepare for a retail transaction, as part of an inventory process, etc. In the present example, the user can employ the mobile device 140 (e.g., during stage (C)) to add items 164 to a list of items (e.g., by interacting with an interface of the device 140 to select representations of the items, by triggering hardware of the device 140 to scan the items and/or capture images of the items, or by using another suitable technique). In response to each item addition, for example, the mobile device 140 can communicate with the facility server 150 to generate transaction data related to the item addition (e.g., during stage (D)). For example, the facility server 150 can access the item datastore 156 to retrieve item data 170a that pertains to the item addition. The item data, for example, can include an item price, an item tax type (e.g., taxable vs. non-taxable), an item weight indicator (e.g., an indication of whether the item is to be sold per unit or by weight), and other relevant item data. In the present example, transaction data 172a (e.g., including item data 170a that pertains to added Item A, Item B, and Item C), can be maintained by the mobile device 140 and/or the facility server 150. A representation of the transaction data 172a, for example, can be presented at the mobile device 140 (e.g., by a device display), which can be updated as items are added to the list of items.

Referring now to FIG. 2C, a pairing process can be initiated between the mobile device 140 and the terminal device 110. In general, the mobile device 140 can be suitably configured for generating a list of items, however the device 140 may be somewhat limited in its ability to complete certain types of transactions (e.g., purchase transactions). For example, due to its portable form factor, the mobile device 140 can include limited data collection hardware (e.g., one or more scanners, a camera, etc.) and/or payment processing capabilities (e.g., a card reader). Such a device may be sufficient for completing purchase transactions that do not involve items that are sold by weight, that do not involve cash payment, or in which a printed receipt is not requested. However, when an initiated and partially complete purchase transaction involves one or more of such factors, it may be advantageous to leverage the capabilities of a stationary transaction terminal (e.g., terminal device 110) that includes one or more peripherals that the mobile device 140 lacks, to complete the transaction (e.g., by using peripherals 112a-d, 132a-n of the terminal device 110 to add items to the item list, to process a payment, to print a physical receipt, etc.). The pairing process, for example, can provide access to one or more peripherals of the terminal device 110 to the mobile device 140, to facilitate the completion of the transaction.

During stage (E), the terminal device 110 can perform a login process with the facility server 150. For example, the user of the mobile device 140 can initiate the login process of the terminal device 110 when the user intends to pair the mobile device 140 with peripherals of the terminal device 110. As another example, a different user may be responsible for the terminal device 110, and can initiate its login process at a time of device pairing, or at a prior time. Peripherals of the terminal device 110, for example, can be available for pairing with multiple different mobile devices 140 over time upon request. To facilitate the login process, for example, the mobile device 140 can provide a login interface (not shown) at its display, through which a user can provide their login credentials (e.g., a user name and password, a personal identification number (PIN), etc.). Providing login credentials, for example, can be accomplished through manual data entry (e.g., interacting with a keypad and/or microphone), use of a scanning hardware of the mobile device 140 (e.g., a code scanner, a biometric scanner, etc.), or another suitable data entry technique. Upon receiving the user's login credentials from the terminal device 110, for example, the facility server 150 can determine whether the received login credentials are valid (e.g., by comparing the received login credentials with stored login credentials available from the credential manager 154).

During stage (F), the terminal device 110 can generate connection information 166 (e.g., including a connection string and/or other connection information) that can be used to identify and/or connect with the device 110. For example, a user of the terminal device 110 can launch a pairing application (e.g., executed by the peripheral device manager 120, shown in FIG. 1) that places the device 110 in a mode that prepares the device 110 for possible peripheral pairing with mobile devices, and the device 110 can generate the connection information 166 in response to launching the pairing application. In some implementations, at least a portion of the connection information 166 can include an identifier of a terminal device. For example, the connection information 166 generated by the terminal device 110 can include a Media Access Control (MAC) address of the terminal device 110, a host name of the terminal device 110, or another sort of device identifier.

During stage (G), the terminal device 110 can output the generated connection information 166 as detectable connection information 180. In some implementations, the detectable connection information can be visually displayed as a scannable code. For example, the display 118 of the terminal device 110 can output the detectable connection information 180 as a quick-response (QR) code, a bar code, or another sort of visual code that is scannable by hardware of the mobile device 140. As another example, the detectable connection information 180 can be a printed code that is affixed to the terminal device 110 (e.g., with the detectable connection information 180 being generated and printed by the terminal device 110, or by a device other than the device 110). In some implementations, the detectable connection information can be presented in a non-visual manner. For example, the terminal device 110 can output the detectable connection information 180 as an audio signal, a wireless signal, or another form of non-visual information.

During stage (H), the mobile device 140 can detect the generated and outputted connection information. For example, the mobile device 140 can use visual detection hardware (e.g., a barcode scanner, a camera, etc.) to visually recognize the connection information 180. As another example, the mobile device 140 can detect the connection information 180 through the use of non-visual detection hardware (e.g., using a microphone to detect an audio signal, using a wireless receiver to detect a wireless signal, etc.).

In some implementations, detection of connection information of a terminal device can be triggered through a peripheral claiming application of the mobile device. For example, the mobile device 140 can present an interface 182 that facilitates the claiming and subsequent releasing of all peripherals of a terminal device (e.g., terminal device 110), or a subset of the peripherals (e.g., one or more of Peripheral A, Peripheral B, Peripheral N, etc.). After launching the peripheral claiming application, for example, the user can be prompted to use the mobile device 140 to detect the connection information 180 of the terminal device. As another example, rather than being output by the terminal device 110 and detected by the device 140 (e.g., a mobile POS device or a stationary POS device), the connection information 180 can be routed to the peripheral claiming application of the device 140 through the facility server 150. Upon receiving the connection information 180, for example, the peripheral claiming application of the device 140 can present an indication (e.g., a visual indication presented in a user interface of the peripheral claiming application) that one or more peripherals of the terminal device 110 are currently available for pairing with the device 140. If the one or more peripherals were later to become unavailable (e.g., as the result of being paired with a different device), the indication of availability can be removed from the user interface of the peripheral claiming application.

In some implementations, the claiming and subsequent releasing of terminal device peripherals can be handled on an ad hoc basis, by software of a transaction building and processing application of a mobile device. For example, after adding items to an item list of the transaction building and processing application, a user of the mobile device 140 can indicate that the transaction is to be finalized. The application, for example, can access the pending transaction data 172a (shown in FIG. 2B), and can determine that at least some of the items are to be weighed (e.g., based on item weight indicators). In response to the determination, for example, the application can prompt the user of the mobile device 140 to locate an available terminal device 110, to initiate a pairing process, and to detect the connection information 180. As another example, when a transaction is to be finalized, a user of the mobile device 140 can indicate that a condition is present for which an external peripheral is to be employed (e.g., the transaction involves a cash payment, a printed receipt is requested, or another sort of condition). In response to the indication of the condition, for example, the application can similarly prompt the user of the mobile device 140 to locate an available terminal device 110, to initiate a pairing process, and to detect the connection information 180. After the terminal device 110 and the mobile device 140 have established trust (as further described in examples below), for example, the transaction building and processing application and claim and release peripherals of the terminal device per the application logic.

Referring now to FIG. 2D, during stage (I) a trust negotiation protocol 190 can be performed to establish trust between the terminal device 110 and the mobile device 140. Briefly, the trust negotiation protocol 190 can include an exchange of certificates between the terminal device 110 and the mobile device 140, with the terminal device 110 providing its terminal device certificate 160b for receipt by the mobile device 140, and with the mobile device 140 providing its mobile device certificate 162b for receipt by the terminal device 110. The certificates 160b, 162b, for example, can be exchanged over the network(s) 102 (shown in FIG. 1), or can be directly exchanged (e.g., using near-field communication (NFC), or another suitable technique). Further, each of the terminal device 110 and the mobile device 140 can independently validate the certificate provided by the other device. For example, the mobile device 140 can communicate with the certificate authority 152 (e.g., via the facility server 150) to validate the terminal device certificate (shown here as certificate 160c), and the terminal device 110 can communicate with the certificate authority 152 (e.g., via the facility server 150) to validate the mobile device certificate (shown here as certificate 162c). By using a private certificate authority (e.g., certificate authority 152) included in the system 100, for example, communication overhead can be reduced when validating device certificates, and security can be improved (e.g., by ensuring that logged in devices are used to validate certificates). The network address of the certificate authority 152, for example, can be referenced in the software code of a pairing application of the terminal device 110 and in a claiming application of the mobile device 140.

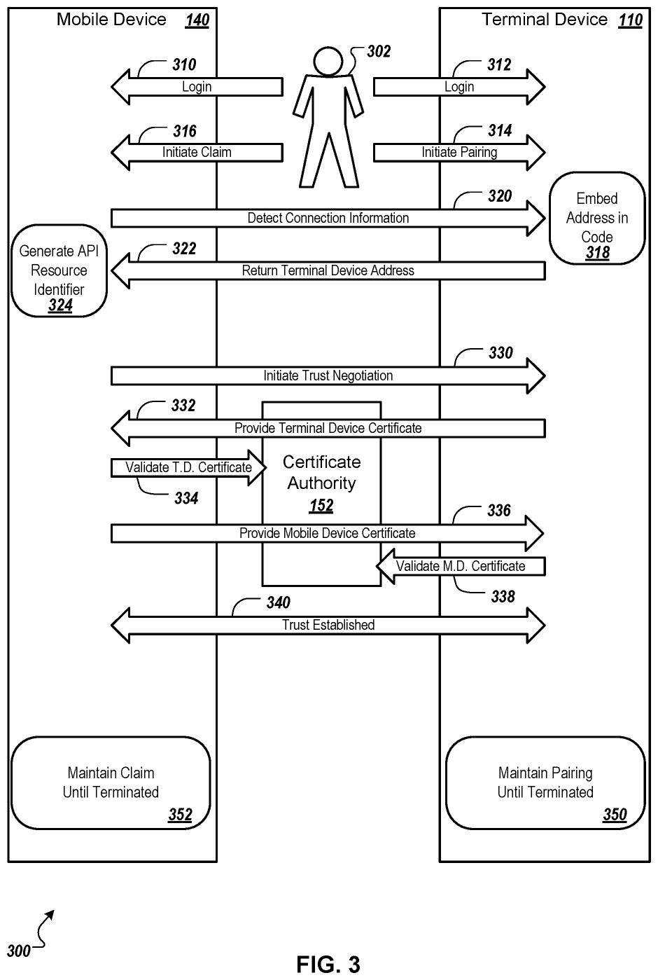

FIG. 3 depicts an example certificate-based trust negotiation protocol 300 for establishing trust between a computing device and a terminal device. The trust negotiation protocol 300, for example, can be conceptually similar to the trust negotiation protocol 190 (shown in FIG. 2D), while including further details related to the protocol 190 and supporting processes. In the present example, the trust negotiation protocol 300 can be performed by the mobile device 140 (also shown in FIG. 1 and FIGS. 2A-2E), the terminal device 110 (also shown in FIG. 1 and FIGS. 2A-2E), and a user 302 (e.g., a user of the mobile device 140 and the terminal device 110).

In general, the trust negotiation protocol 300 can occur when logins have been performed at each of the mobile device 140 and the terminal device 110, and active sessions are in place at each device. At 310, the user 302 can perform a login process to log in to the mobile device 140. The mobile device login process, for example, can be performed using techniques described with respect to stage (B) (shown in FIG. 2A). At 312, the user 302 (or a different user) can perform a login process to log in to the terminal device 110. The terminal device login process, for example, can be performed using techniques described with respect to stage (E) (shown in FIG. 2C). As previously described, the terminal device login process (312) may occur before or after the mobile device login process (310).

At 314, a pairing process can be initiated at the terminal device 110, and at 316, a peripheral claiming process can be initiated at the mobile device 140. The pairing process at the terminal device 110, for example, can be performed using techniques described with respect to stages (F) and (G) (shown in FIG. 2C). For example, the user 302 can launch a pairing application on the terminal device 110 in initiate the pairing process. The peripheral claiming process at the mobile device 140, for example, can be performed using techniques described with respect to stage (H) (also shown in FIG. 2C). For example, the user 302 can launch a peripheral claiming application on the mobile device 140 to initiate the peripheral claiming process. As another example, the user 302 can interact with a transaction building and processing application on the mobile device 140, which can initiate the peripheral claiming process by prompting the user at an appropriate time (e.g., by prompting the user 302 to use the mobile device 140 to detect the connection information 180 that is output by the terminal device 110, when particular peripherals are to be used by the application). The peripheral claiming process can be initiated (316) at the mobile device 140 before or after the pairing process is initiated (314) at the terminal device 110.

At 318, information that can be used to establish a connection with the terminal device 110 (e.g., an address, host name, and/or another sort of identifier of the terminal device 110) can be provided. As described with respect to stages (F) and (G) (shown in FIG. 2C), for example, in response to the launching of a pairing application at the terminal device 110, connection information for the terminal device 110 (e.g., the device's Medial Access Control (MAC) address, host name, or another sort of device identifier) can provided as connection information 180 (e.g., by embedding the information into a code) that is generated and output by the terminal device 110. In some implementations, a pairing application of a terminal device can include a timeout condition that limits an amount of time that connection information is output by the terminal device. For example, after the pairing application is launched at the terminal device 110, the device 110 can present the connection information 180 (shown in FIG. 2C) for possible detection by a mobile device for a limited amount of time (e.g., fifteen seconds, thirty seconds, a minute, or another suitable period of time). If a peripheral claiming process is not initiated by a mobile device within the limited amount of time, for example, the terminal device 110 can terminate the pairing application, and can revert to a previous application. As another example, if the peripheral claiming process is not initiated within the limited amount of time, the terminal device 110 can terminate the pairing application, log out a currently logged in user, and can present a login screen for a new login.

At 320, the connection information can be detected by the mobile device 140, and at 322, the connection information for the terminal device 110 (e.g., the address, host name, and/or other sort of identifier of the terminal device 110) can be returned to the mobile device 140. As described with respect to stage (H) (shown in FIG. 2C), for example, the mobile device 140 can detect the connection information 180 that is output by the terminal device 110. After detecting the connection information 180, for example, the mobile device 140 can extract the connection information of the terminal device 110 (e.g., from a code in which the connection information has been embedded), and can provide the extracted connection information to a peripheral claiming function of the mobile device.

At 324, an application programming interface (API) resource identifier can be generated by the mobile device 140. For example, the mobile device 140 can use the extracted connection information of the terminal device 110 and can generate an API resource identifier of the terminal device 110 that can be used to locate the terminal device on the network(s) 102 (shown in FIG. 1), and that can be used to potentially access the peripheral APIs 128 of the peripherals 132a-n (also shown in FIG. 1) of the terminal device 110. However, before accessing the peripheral APIs 128 of the peripherals 132a-n, for example, the trust negotiation protocol 190 (shown in FIG. 2D) is to be performed between the terminal device 110, the mobile device 140, and the facility server 150, which is described in further detail below with respect to arrows 330-340.

At 330, the mobile device 140 can initiate a trust negotiation with the terminal device 110. For implementations in which the mobile device 140 and the terminal device 110 are configured to communicate with each other over the network(s) 102, for example, the mobile device 140 can use the extracted connection information (e.g., address, host name, and/or other sort of identifier) of the terminal device 110 to send a trust negotiation initiation message to the terminal device 110 over the network(s) 102. For implementations in which the mobile device 140 and the terminal device are configured to communicate with each other directly (e.g., using a short-range wireless technology such as Wi-Fi, Bluetooth, near-field communication (NFC), etc.), for example, the mobile device 140 can use the extracted connection information of the terminal device 110 to send a trust negotiation initiation message directly to the terminal device 110.

In some implementations, a trust negotiation initiation message transmitted by a mobile device can be a call to an application programming interface (API) of a pairing application of a terminal device. For example, the trust negotiation initiation message sent by the mobile device 140 to the terminal device 110 (e.g., either directly or through network(s) 102) can call a trust negotiation initiation function included in the API of the pairing application of the terminal device 110. The API call to the trust negotiation initiation function, for example, can include an identifier of the mobile device 140 (e.g., a Media Access Control (MAC) address, a host name, or another sort of device identifier), and the trust negotiation initiation function can be configured to facilitate trust negotiation processes with mobile devices.

In some implementations, communications between a mobile device and a terminal device can occur over a secure communication protocol (e.g., using a cryptographic protocol such as Transport Layer Security (TLS), or another secure communication protocol). For example, when initiating the trust negotiation (at 330), the mobile device 140 can request that the terminal device 110 set up a secure connection (e.g., a secure TLS connection or another sort of secure connection) between the terminal device 110 and the mobile device 140. Setting up the secure connection, for example, can include a handshaking process in which the mobile device 140 and the terminal device 110 establish various parameters and settings to be used during a communication session, such as cipher and hash functions for to be used for encryption/decryption, keys to be used for encrypting/decrypting transmitted data, and other suitable session parameters and settings.

At 332, the terminal device 110 can transmit its terminal device certificate 160b (shown in FIG. 2D) to the mobile device 140. For example, in response to receipt of the trust negotiation initiation from the mobile device 140, the terminal device 110 can retrieve the terminal device certificate 160b from local storage (e.g., a key store), and can transmit the certificate 160b to the mobile device 140 either directly or through network(s) 102. The terminal device 110, for example, can transmit the terminal device certificate 160b over the secure connection established between the mobile device 140 and the terminal device 110.

At 334, the mobile device 140 can determine whether the terminal device certificate (here shown as certificate 160c) is a valid certificate, based on information provided by the certificate authority 152 via the facility server 150 (e.g., over a separate secure connection established between the mobile device 140 and the certificate authority 152 over the network(s) 102). In some implementations, a mobile device can perform a certificate validation. The certificate authority 152, for example, can provide its public key to the mobile device 140 (e.g., at 334, or at a time prior to 334), and the mobile device 140 can use the public key of the certificate authority 152 to determine whether the received terminal device certificate 160c has been signed (e.g., with a corresponding private key of the certificate authority 152) and issued by the certificate authority 152. After validating the terminal device certificate 160c, for example, the mobile device 140 can query the certificate authority 152, to ensure that the certificate 160c has not been revoked. In some implementations, a certificate authority can perform a certificate validation. For example, the mobile device 140 can transmit the received terminal device certificate 160c to the certificate authority 152, which can in turn validate the certificate 160c, determine whether the certificate 160c has been revoked, and return a value that indicates whether the certificate 160c is currently valid or invalid.

At 336, the mobile device 140 can transmit its mobile device certificate 162b (shown in FIG. 2D) to the terminal device 110. The mobile device 140, for example, can retrieve the mobile device certificate 162b from local storage (e.g., a key store), and can transmit the certificate 162b to the terminal device 110 either directly or through network(s) 102. For example, after determining the terminal device certificate 160c is a valid certificate, the mobile device 140 can retrieve and transmit the mobile device certificate 162 over the secure connection established between the mobile device 140 and the terminal device 110.

At 338, the terminal device 110 can determine whether the mobile device certificate (here shown as certificate 162c) is a valid certificate, based on information provided by the certificate authority 152 via the facility server 150 (e.g., over a separate secure connection established between the terminal device 110 and the certificate authority 152 over the network(s) 102). In some implementations, a terminal device can perform a certificate validation. The certificate authority 152, for example, can provide its public key to the terminal device 110 (e.g., at 338, or at a time prior to 338), and the terminal device 110 can use the public key of the certificate authority 152 to determine whether the received mobile device certificate 162c has been signed (e.g., with a corresponding private key of the certificate authority 152) and issued by the certificate authority 152. After validating the mobile device certificate 162c, for example, the terminal device 110 can query the certificate authority 152, to ensure that the certificate 162c has not been revoked. In some implementations, a certificate authority can perform a certificate validation. For example, the terminal device 110 can transmit the received mobile device certificate 162c to the certificate authority 152, which can in turn validate the certificate 162c, determine whether the certificate 162c has been revoked, and return a value that indicates whether the certificate 162c is currently valid or invalid.

At 340, after the terminal device 110 and the mobile device 140 have exchanged their respective certificates and have each independently validated the certificate of the other device, trust can be established between the devices 110, 140. That is, the mobile device 140 and the terminal device 110 can each trust that the other device has been authorized by the facility server 150 to operate in the system 100, and can conduct further communications securely and in confidence (e.g., by sending encrypted data through a Secure Socket Layer (SSL) tunnel, or another secure communication protocol). The communications between the mobile device 140 and the terminal device 110, for example, can include a claiming of one or more peripherals of the terminal device 110 by the mobile device 140, and a maintaining of a pairing between the devices 110, 140. While the devices/peripherals are paired, for example, peripheral device commands can be routed from the mobile device 140 to the terminal device 110, and peripheral device data can be routed from the terminal device 110 to the mobile device 140, as described in examples below and elsewhere in this document.

At 350, the terminal device 110 can maintain a pairing with the mobile device 140 until the pairing is terminated. For example, the pairing application of the terminal device 110 can receive claims from the mobile device 140 for one or more peripherals of the terminal device 110, and can grant or deny the claims according to its application logic. If another transaction application is launched at the terminal device 110 (e.g., a user of the device 110 asserts control of the device 110 to complete another transaction), for example, the pairing application of the terminal device 110 may terminate the active pairing between the terminal device 110 and any mobile devices (e.g., mobile device 140). As another example, the pairing application 110 may maintain the active pairing, but selectively terminate some peripheral claims (e.g., claims for peripherals which are to be used by the terminal device 110. As another example, the pairing application 110 may maintain an active pairing until a timeout condition has occurred.

At 352, the mobile device 140 can maintain one or more claims for peripherals of the terminal device 110 until the claim(s) are terminated. For example, an application running on the mobile device 140 (e.g., a peripheral claiming application, a transaction building and processing application, or another sort of application) can submit claims for one or more peripherals of the terminal device 110 according to its application logic, and the claims may be granted or denied by the terminal device 110. If granted, for example, the claim can be maintained by the mobile device 140 until it is terminated by the terminal device 110, or until it is terminated by the mobile device 140 (e.g., the claim is released by the peripheral claiming application of the mobile device 140 after a transaction is completed, a claim for peripherals of a different terminal device is initiated by the mobile device 140, or another sort of scenario occurs in which the mobile device 140 may terminate the claim(s)).

Referring now to FIG. 2E, during stage (J), a claim 168 for one or more peripherals can be granted by the terminal device 110. In response to receiving claims for one or more peripherals of the terminal device 110 (e.g., a claim for all peripherals, or a claim for a specific subset of peripherals) from the application running on the mobile device 140 (e.g., a peripheral claiming application, a transaction building and processing application, or another sort of application), for example, the terminal device 110 can grant the claims. In some implementations, a terminal device can provide an indication that a peripheral claiming request has been granted or denied. For example, the terminal device 110 can present an indication that the peripheral claims have been granted (e.g., at the display 118, which indicates that the terminal device 110 has been paired with the mobile device 140 (“Mobile Device X”)). As another example, the terminal device 110 can provide the indication that the peripheral claims have been granted to the mobile device 140, which can use the indication to update an interface of a peripheral claiming application (e.g., the interface 182, shown in FIG. 2C), and/or can provide the indication to application logic running on the mobile device 140 (e.g., application logic of a transaction building and processing application).

In some implementations, a device pairing audit log can be updated that records details of claim requests and related device pairings. For example, the facility server 150 can maintain and update a device pairing audit log to indicate that the mobile device 140 has claimed one or more peripherals of the terminal device 110 (e.g., including a list of the particular peripherals being claimed, or an indication that all peripherals are being claimed), and whether the claim was granted or denied by the terminal device 110. Additional data related to the claim/pairing, for example, can include an identifier of a logged in user of the mobile device 140, an identifier of a logged in user of the terminal device 110, a date/timestamp of the request, and a date/timestamp at which the claim/pairing was terminated. In another example, the mobile device 140 and the terminal device 110 can each maintain separate device pairing audit logs that record the details of claim requests and related device pairings (e.g., such as at the peripheral claim datastore 124 of the peripheral device manager 120).

During stage (K), the mobile device 140 can access one or more peripherals of the terminal device 110. For example, an application running on the mobile device 140 (e.g., a peripheral claiming application, a transaction building and processing application, or another sort of application) can transmit peripheral device commands to one or more claimed peripherals, and/or can receive data from the peripheral(s). Communication between the mobile device 140 and the terminal device 110, for example, can occur over the network(s) 102 (shown in FIG. 1), or can be direct communications (e.g., using near-field communication (NFC), or another suitable protocol). For example, communication between the mobile device 140 and the terminal device 110 to facilitate access by the mobile device 140 of the peripherals 132a-n of the terminal device 110 can occur over the secure connection established during the trust negotiation protocol 190 (e.g., during stage (I), shown in FIG. 2D).

In some implementations, a computing device (e.g., a mobile or stationary POS device) can access peripherals of a terminal device by using an application programming interface (API) framework of the terminal device. The mobile device 140, for example, can access peripheral 132a (e.g., “Peripheral A”) of the terminal device 110 by making one or more API calls (e.g., through its peripheral claiming application, transaction building and processing application, or another sort of mobile device application) to one or more of the peripheral APIs 128 that provide an interface to the peripheral 132a. Similarly, the mobile device 140 can access any of the other peripherals 132b-n of the terminal device by making API call(s) to their respective peripheral APIs 128.

In the present example, a user can be in the process of employing the mobile device 140 to execute a transaction building and processing application, to generate data for a list of items (e.g., including Item A, Item B, and Item C, represented in the transaction data 172a, shown in FIG. 2B) in preparation of a retail transaction. The user in the present example intends to add “Item D” (e.g., an item that is sold by weight) to the list of items-however, the mobile device 140 lacks a scale. After pairing the mobile device 140 with the terminal device 110 and claiming the appropriate peripheral device(s) of the terminal device 110 (e.g., peripheral 132a, or “Peripheral A,” which can represent a scale in this example), the transaction building and processing application can call one or more peripheral APIs 128 that are used to interface with the peripheral 132a. The peripheral device manager 120, for example, can receive the API call(s), and can use the peripheral claim manager 122 to verify whether the terminal device 110 is permitted to access the requested peripheral (e.g., peripheral 132a) based on information available from the peripheral claim datastore 124. If so, the peripheral device manager 120 can allow the API call, and can use the peripheral controller 126 to communicate relevant data to and from the peripheral 132a (e.g., over the bus 130), based on functions and parameters associated with the API call. For example, the peripheral controller 126 can enable peripheral 132a (e.g., a scale), can wait for data to be returned from peripheral 132a (e.g., weight data), and can return a value based on the peripheral data (e.g., a weight value) to the appropriate peripheral API 128. The peripheral data in the present example (e.g., the weight value) can be transmitted by the terminal device 110 to the mobile device 140, and the mobile device 140 can add the peripheral data to the transaction data (here shown as transaction data 172b) being generated by the transaction building and processing application. For example, the mobile device 140 can access the facility server 150 to receive item data 170b for “Item D” from the item datastore 156 (e.g., an item price per weight, an item tax type, etc.), and can supplement the received item data 170b with the data received from the peripheral 132a (e.g., the item's weight value) to prepare for the retail transaction.

During stage (L), the transaction can be finalized. In the present example, after the transaction building and processing application of the mobile device 140 has finished preparing for the retail transaction (e.g., the mobile device has finished adding to the transaction data 172b), the mobile device 140 can submit the transaction to the facility server 150. The facility server 150, for example, can generate a record of the transaction and can notify the mobile device 140 when the transaction finalization is complete. Optionally, the mobile device 140 can continue to access peripherals 132a-n of the terminal device 110 during and/or after finalization of the transaction. For example, the mobile device 140 can access a payment terminal and/or a cash drawer of the terminal device 110 during finalization of the transaction, and/or can access a receipt printer of the terminal device 110 (e.g., to print a record of the transaction) after finalization of the transaction is complete. After the transaction has been completed, for example, the mobile device 140 can release its claim of the peripherals 132a-n of the terminal device 110, and the terminal device 110 can terminate the pairing (e.g., by using the peripheral claim manager 122 to update the peripheral claim datastore 124).

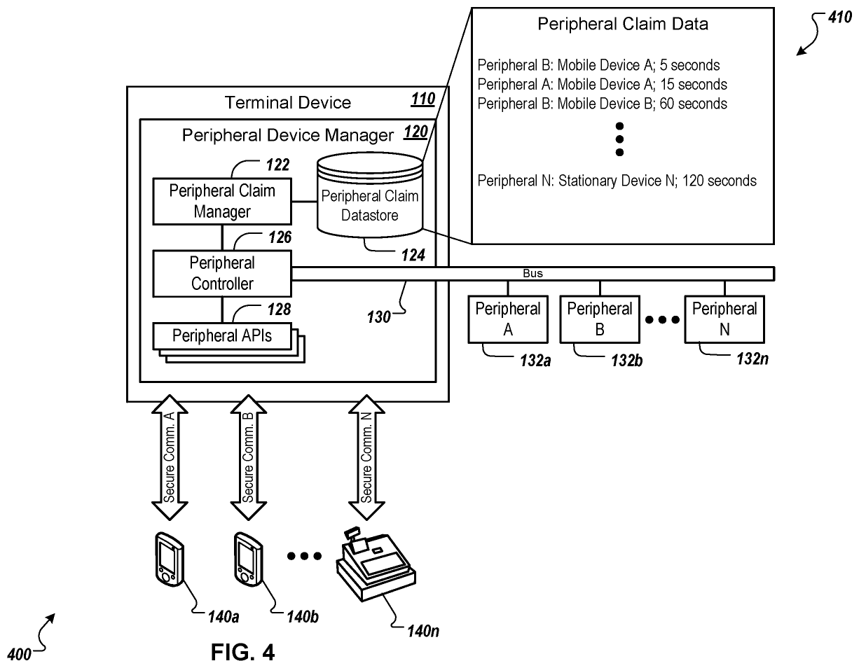

FIG. 4 is a conceptual diagram of example established pairings 400 between computing devices 140a-n (e.g., including mobile computing devices and/or stationary computing devices) and terminal device peripherals 132a-n. In general, a terminal device can receive claim requests for its peripherals from various other devices, can grant or deny the claims, and can maintain device pairings until the claims/pairings are terminated. In the present example, the terminal device 110 (e.g., also shown in FIG. 1, FIGS. 2A-E, and FIG. 3) can receive claim requests for its peripherals 132a-n (e.g., also shown in FIG. 1, FIGS. 2A-E, and FIG. 3) from one or more of the computing devices 140a-n (e.g., similar to mobile device 140, also shown in FIG. 1, FIGS. 2A-E, and FIG. 3, and/or including one or more stationary computing devices, such as checkout registers or other stationary computing devices), and can maintain and manage possible pairings between the computing devices 140a-n and the peripherals 132a-n over time.

In some implementations, a terminal device can be paired with a single other device at a single time. For example, the terminal device 110 can receive a claim for one or more of its peripherals 132a-n (e.g., a claim for a particular one of the peripherals 132a-n, a claim for a particular subset of the peripherals 132a-n, or a claim for all of the peripherals 132a-n) from one of the computing devices 140a-n (e.g., computing device 140a), and can maintain the pairing with computing device 140a until terminated by the terminal device 110, or until the claim is released by computing device 140a. If the computing device 140a were to attempt to claim one or more peripherals 132a-n of the terminal device 110, for example, the terminal device 110 may or may not grant the claim(s). If the claim(s) are granted, for example, the terminal device 110 can maintain data associated with a pairing between the claimed peripheral(s) and the computing device 140a (e.g., at the peripheral claim datastore 124). In the present example, if another computing device (e.g., either computing device 140b or computing device 140n) were to attempt to claim one or more peripherals 132a-n of the terminal device 110 while the pairing between the terminal device 110 and the computing device 140a is active, the terminal device 110 may check the peripheral claim datastore 124 for active pairings, determine that the pairing with computing device 140a is active, and deny the claim of the other computing device. As another example, the terminal device 110 may place the claim for one or more peripherals from the other device (e.g., either computing device 140b or computing device 140n) in a queue of claim requests (e.g., maintained at the peripheral claim datastore 124), and may grant the claim at a later time (e.g., after the present claim is released or the present pairing is terminated).

In some implementations, a terminal device can be paired with multiple other devices at the same time. For example, the terminal device 110 can receive claims for its peripherals 132a-n from multiple different computing devices 140a-n (e.g., with the terminal device 110 communicating with each respective computing device over separate secure communication channels), and can concurrently maintain pairings with each of the computing devices 140a-n until claims are released by the respective computing devices 140a-n, or until pairings are terminated by the terminal device 110. Based on its application logic, for example, the terminal device 110 can selectively terminate pairings between particular peripherals 132a-n and particular computing devices 140a-n. If the terminal device 110 were to be used for performing a transaction, and the transaction were to involve all of the peripherals 132a-n, for example, the terminal device 110 may access the peripheral claim datastore 124 to identify any computing devices 140a-n with which an active pairing is in place, and terminate all active pairings. As another example, the terminal device 110 may terminate pairings between computing devices and some peripherals, while maintaining pairings between computing devices and other peripherals.

In some implementations, different types of peripherals may be associated with different pairing relationships, based on peripheral capabilities and characteristics. For example, some peripherals may be associated with a one-to-one pairing relationship, with the peripheral being paired with a single computing device (or being employed solely by a terminal device), whereas other peripherals may be associated with a one-to-many pairing relationship, with the peripheral possibly being concurrently paired with multiple different computing devices (as well as being employed by the terminal device). In general, a peripheral that is configured to collect and provide item data (e.g., a scanner, a scale, etc.) and/or user data (e.g., a payment terminal) can be associated with a one-to-one pairing relationship, since the data being collected and provided by the peripheral is intended for a particular transaction being generated by a particular computing device. However, a peripheral that is configured to output data (e.g., a printer) can be associated with a one-to-many pairing relationship with computing devices, since a peripheral output (e.g., a receipt or another form of output) can be differentiated and retrieved by a user of the computing device after it is output. As another example, a peripheral that is configured to operate on control commands from a computing device (e.g., a cash drawer) may be associated with a one-to-one pairing relationship, or a one-to-many pairing relationship, depending on the application logic of the terminal device 110.

In the present example, each of the computing devices 140a, 140b, and 140n can have a separate secure connection to facilitate communication with the terminal device 110, and each of the computing devices can claim one or more peripherals 132a-n of the terminal device 110 over time. For example, the computing devices 140a, 140b, and 140n can each execute transaction building and processing applications, and can each concurrently be in the process of building/finalizing respective retail transactions. While building/finalizing the transactions, for example, the transaction building and processing applications can submit peripheral claims to the terminal device 110, to request a suitable peripheral of the terminal device 110 to facilitate its transaction building/finalizing process.

As shown in the present example, at a first time (e.g., 120 seconds ago), the computing device 140n (e.g., “Stationary Device N”) can submit a claim to the terminal device 110 for peripheral 132n (e.g., “Peripheral N,” which here represents a payment terminal). The terminal device 110, for example, can use its peripheral claim manager 122 to determine that the requested peripheral 132n is not to be concurrently shared among multiple devices (e.g., the peripheral is associated with a one-to-one pairing relationship), and to determine that the requested peripheral 132n is not currently being shared with another device (e.g., based on peripheral claim data 410 available from the peripheral claim datastore 124). Thus, in the present example, the terminal device 110 can grant the claim, and can maintain a pairing between the computing device 140n and the peripheral 132n.

Continuing the present example, at a second time (e.g., 60 seconds ago), the computing device 140b (e.g., “Mobile Device B”) can submit a claim to the terminal device 110 for peripheral 132b (e.g., “Peripheral B,” which here represents a printer). The terminal device 110, for example, can use its peripheral claim manager 122 to determine that the requested peripheral 132b can be concurrently shared among multiple computing devices (e.g., the peripheral is associated with a one-to-many pairing relationship). Thus, in the present example, the terminal device 110 can grant the claim, and can maintain a pairing between the computing device 140b and the peripheral 132b.

Continuing the present example, at a third time (e.g., 15 seconds ago), the computing device 140a (e.g., “Mobile Device A”) can submit a claim to the terminal device 110 for peripheral 132a (e.g., “Peripheral A,” which here represents a scale). The terminal device 110, for example, can use its peripheral claim manager 122 to determine that the requested peripheral 132a is not to be concurrently shared among multiple devices (e.g., the peripheral is associated with a one-to-one pairing relationship), and to determine that the requested peripheral 132 is not currently being shared with another device (e.g., based on peripheral claim data 410 available from the peripheral claim datastore 124). Thus, in the present example, the terminal device 110 can grant the claim, and can maintain a pairing between the computing device 140a and the peripheral 132a. If the computing device 140a were to have submitted a claim to the terminal device 110 for its peripheral 132n, however, the terminal device 110 may determine that the peripheral 132n is currently being shared with another device (e.g., the peripheral 132n is currently paired with the computing device 140n, based on the peripheral claim data 410), and the terminal device 110 may deny the claim.

Continuing the present example, at a fourth time, (e.g., 5 seconds ago), the computing device 140a (e.g., “Mobile Device A”) can submit another claim to the terminal device 110, at this time for peripheral 132b (e.g., “Peripheral B,” which here represents the printer). The terminal device 110, for example, can use its peripheral claim manager 122 to determine that the requested peripheral 132b can be concurrently shared among multiple devices, and can thus grant the claim even though the peripheral 132b is currently paired with another device (e.g., “Mobile Device B”). In the present example, the terminal device 110 can concurrently maintain pairings with the peripheral 132b and multiple different computing devices (e.g., both computing device 140a and computing device 140b).

In some implementations, pairings may be maintained until a termination condition occurs. For example, after claiming peripheral 132b (e.g. “Peripheral B,” the printer), the computing device 140b can request that peripheral 132b print a receipt. After the receipt has been printed, for example, the computing device 140b can finalize a pending transaction, and can release its claim of peripheral 132b. In response, the terminal device 110 can use the peripheral claim manager 122 to update the peripheral claim data 410 of the peripheral claim datastore 124 to reflect the released claim. As another example, the computing device 140a can release its claim of peripheral 132a (e.g., “Peripheral A,” the scale), either after receiving data from the peripheral 132a or after finalizing a pending transaction, but can maintain its claim of peripheral 132b (e.g., the printer) after releasing its claim of peripheral 132a (e.g., to request that subsequent printing tasks be performed). As another example, the peripheral claim manager 122 can determine that a timeout condition has occurred for peripheral 132n and can terminate its active pairing. For example, the peripheral claim manager 122 can compare an amount of time that has elapsed since the peripheral 132n has been paired with the computing device 140n, to a timeout threshold maintained for the peripheral 132n. In the present example, the peripheral claim manager 122 can determine that the elapsed time has met the timeout threshold for the peripheral 132n (e.g., 120 seconds, or another suitable threshold value), and can terminate the pairing between the peripheral 132n and the computing device 140n.

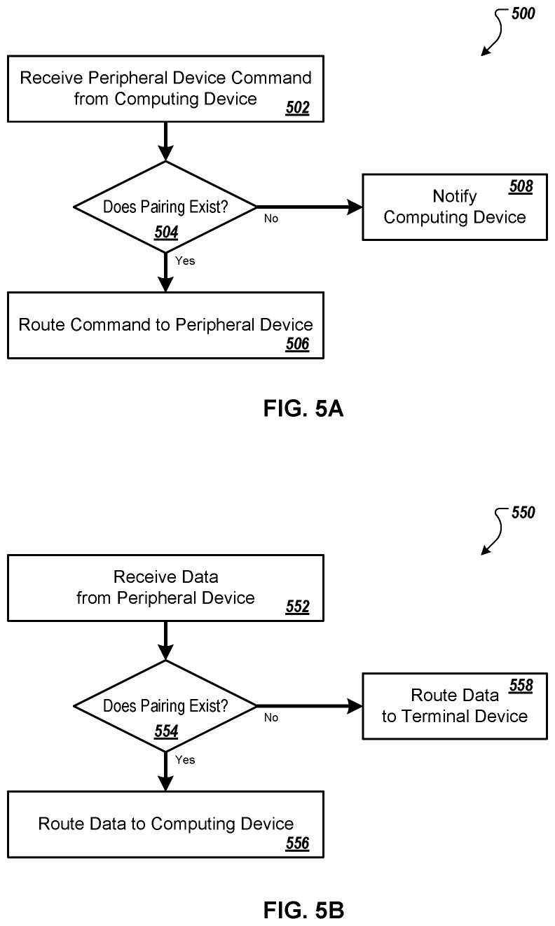

FIG. 5A is a flow diagram of an example technique 500 for routing commands from a computing device to a paired terminal device peripheral. The technique 500, for example, can be performed after the computing device has claimed and has been paired with the peripheral. In the present example, the technique 500 can be performed by components of the system 100 (shown in FIG. 1, FIGS. 2A-E, and FIG. 3), and will be described with respect to the components shown in the example of the established pairings 400 (shown in FIG. 4).

At 502, a peripheral device command can be received from a computing device. For example, the computing device 140a can transmit a command for peripheral 132b (e.g., “Peripheral B,” which here represents a printer). The peripheral device command, for example, can include a call to an application programming interface (API) of the peripheral 132b (e.g., one of the peripheral APIs 128). In the present example, the peripheral device manager 120 of the terminal device 110 can receive the peripheral device command (e.g., a command to print a record of a transaction) from the computing device 140a over the secure communication channel between the terminal device 110 and the computing device 140a.

At 504, a determination can be performed of whether an active pairing exists. For example, the peripheral claim manager 122 of the peripheral device manager 120 can access peripheral claim data 410 of the peripheral claim datastore 124 to determine whether the device that transmitted the command (e.g., computing device 140a) currently has an active pairing with the peripheral for which the command is intended (e.g., peripheral 132b).

At 506, if the active pairing exists, the command can be routed to a corresponding peripheral device. In the present example, the peripheral claim manager 122 can determine that the computing device 140a currently has an active pairing with peripheral 132b, and can route the command to the peripheral 132b. For example, the peripheral device manager 120 can permit the call to the API of the peripheral 132b (e.g., one of the peripheral APIs 128), which can in turn provide the command to the peripheral controller 126, which can route the command to peripheral 132b via the bus 130.

At 508, if the active pairing does not exist, the computing device can be notified. For example, in response to determining that an active pairing does not exist between the computing device 140a and the peripheral 132b, the peripheral device manager 120 can provide a return value to the computing device 140a that indicates that the command was unsuccessful. Optionally, additional contextual information related to a reason for the error can also be provided by the peripheral device manager 120.

FIG. 5B is a flow diagram of an example technique 550 for routing data from a terminal device peripheral to a paired terminal device. The technique 500, for example, can be performed after the computing device has claimed and has been paired with the peripheral. In the present example, the technique 500 can be performed by components of the system 100 (shown in FIG. 1, FIGS. 2A-E, and FIG. 3), and will be described with respect to the components shown in the example of the established pairings 400 (shown in FIG. 4).

At 552, data can be received from a peripheral device. For example, the peripheral 132a (e.g., “Peripheral A,” which here represents a scale) can generate data in response to a triggering event (e.g., an item being placed on the scale, a request for a current device reading, etc.). In the present example, in response to the triggering event, a weight value that corresponds to an item being measured by the peripheral 132a can be transmitted along the bus 130 to the peripheral controller 126.

At 554, a determination can be performed of whether an active pairing exists. In response to receiving the data from the peripheral 132a, for example, the peripheral controller 126 can access the peripheral claim manager 122 to identify a device for which the received data is intended. The peripheral claim manager 122 of the peripheral device manager 120, for example, can access peripheral claim data 410 of the peripheral claim datastore 124 to determine the intended device (e.g., a device that is currently paired with the peripheral 132a).

At 556, if the active pairing exists, data can be routed to a computing device. In the present example, the peripheral claim manager 122 can determine that the computing device 140a (“Mobile Device A”) currently has an active pairing with peripheral 132a (e.g., the scale), and that the pairing relationship for the peripheral 132a is a one-to-one pairing relationship. Thus, the peripheral device manager 120 can route the data (e.g., the weight value) to the computing device 140a via the secure communication channel between the computing device 140a and the terminal device 110 (e.g., using one of the peripheral APIs 128).

At 558, if the active pairing does not exist, data can be routed to a terminal device. Absent an active pairing between the peripheral 132a and any particular computing device, for example, the peripheral device manager 120 can simply route the data directly from the peripheral controller 126 to the terminal device 110. For example, if one of the computing devices 140a-n is not currently paired with the peripheral 132a, the terminal device 110 may currently be used to locally build a transaction.

Although the example techniques 500, 550 illustrate scenarios in which a terminal device can potentially maintain pairings with multiple different computing devices, other examples can involve scenarios in which a terminal device can either maintain a single device pairing at a time, or no pairing. In such scenarios, the peripheral device manager 120 may simply leverage the existence of an active secure communication channel with a computing device as an indication of whether an active pairing exists. Such scenarios, for example, may thus involve the routing of commands and data over the active secure communication channel, without using a peripheral claim manager (e.g., the peripheral claim manager 122) to track current device pairings and to identify active pairings with particular devices.

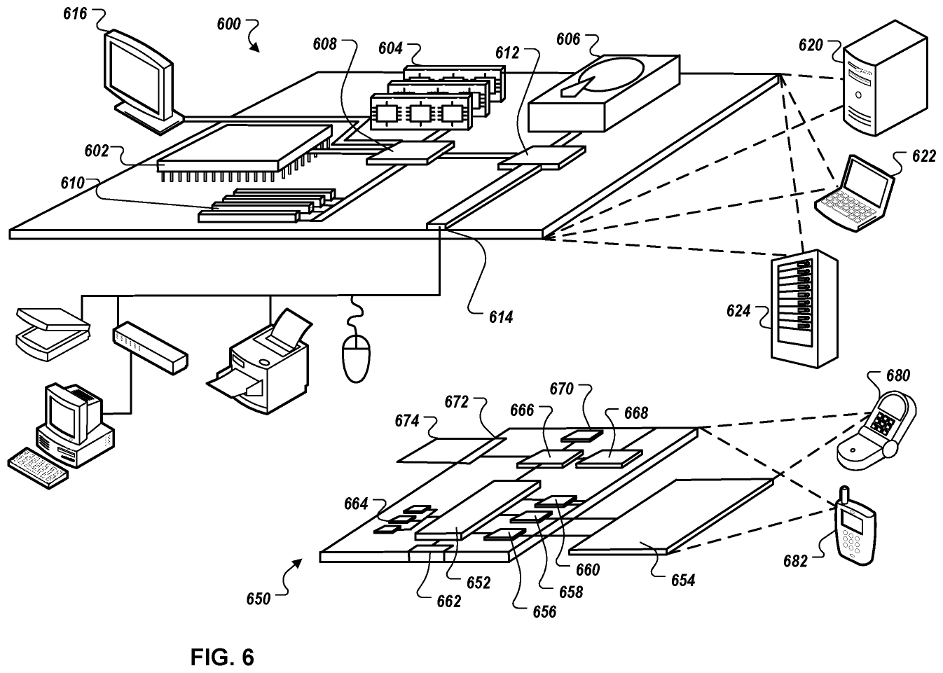

FIG. 6 shows an example of a computing device 600 and an example of a mobile computing device 650 that can be used to implement the techniques described here. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the computing device 600. In some implementations, the storage device 606 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In the implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. In addition, it can be implemented in a personal computer such as a laptop computer 622. It can also be implemented as part of a rack server system 624. Alternatively, components from the computing device 600 can be combined with other components in a mobile device (not shown), such as a mobile computing device 650. Each of such devices can contain one or more of the computing device 600 and the mobile computing device 650, and an entire system can be made up of multiple computing devices communicating with each other.

The mobile computing device 650 includes a processor 652, a memory 664, an input/output device such as a display 654, a communication interface 666, and a transceiver 668, among other components. The mobile computing device 650 can also be provided with a storage device, such as a micro-drive or other device, to provide additional storage. Each of the processor 652, the memory 664, the display 654, the communication interface 666, and the transceiver 668, are interconnected using various buses, and several of the components can be mounted on a common motherboard or in other manners as appropriate.

The processor 652 can execute instructions within the mobile computing device 650, including instructions stored in the memory 664. The processor 652 can be implemented as a chipset of chips that include separate and multiple analog and digital processors. The processor 652 can provide, for example, for coordination of the other components of the mobile computing device 650, such as control of user interfaces, applications run by the mobile computing device 650, and wireless communication by the mobile computing device 650.

The processor 652 can communicate with a user through a control interface 658 and a display interface 656 coupled to the display 654. The display 654 can be, for example, a TFT (Thin-Film-Transistor Liquid Crystal Display) display or an OLED (Organic Light Emitting Diode) display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can provide communication with the processor 652, so as to enable near area communication of the mobile computing device 650 with other devices. The external interface 662 can provide, for example, for wired communication in some implementations, or for wireless communication in other implementations, and multiple interfaces can also be used.

The memory 664 stores information within the mobile computing device 650. The memory 664 can be implemented as one or more of a computer-readable medium or media, a volatile memory unit or units, or a non-volatile memory unit or units. An expansion memory 674 can also be provided and connected to the mobile computing device 650 through an expansion interface 672, which can include, for example, a SIMM (Single In Line Memory Module) card interface. The expansion memory 674 can provide extra storage space for the mobile computing device 650, or can also store applications or other information for the mobile computing device 650. Specifically, the expansion memory 674 can include instructions to carry out or supplement the processes described above, and can include secure information also. Thus, for example, the expansion memory 674 can be provide as a security module for the mobile computing device 650, and can be programmed with instructions that permit secure use of the mobile computing device 650. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 can communicate wirelessly through the communication interface 666, which can include digital signal processing circuitry where necessary. The communication interface 666 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 668 using a radio-frequency. In addition, short-range communication can occur, such as using a Bluetooth, WiFi, or other such transceiver (not shown). In addition, a GPS (Global Positioning System) receiver module 670 can provide additional navigation- and location-related wireless data to the mobile computing device 650, which can be used as appropriate by applications running on the mobile computing device 650.

The mobile computing device 650 can also communicate audibly using an audio codec 660, which can receive spoken information from a user and convert it to usable digital information. The audio codec 660 can likewise generate audible sound for a user, such as through a speaker, e.g., in a handset of the mobile computing device 650. Such sound can include sound from voice telephone calls, can include recorded sound (e.g., voice messages, music files, etc.) and can also include sound generated by applications operating on the mobile computing device 650.

The mobile computing device 650 can be implemented in a number of different forms, as shown in the figure. For example, it can be implemented as a cellular telephone 680. It can also be implemented as part of a smart-phone 682, personal digital assistant, or other similar mobile device.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer system for securely pairing a computing device with peripherals of a terminal device, the system comprising:
the computing device, wherein the computing device includes a wireless communication interface;
the terminal device, wherein the terminal device includes a wired communication interface and a wireless communication interface, wherein the peripheral devices of the terminal device are each configured to communicate with the terminal device using the wired communication interface of the terminal device; and
a facility server;
wherein the computing device, the terminal device, and the facility sever each include one or more processors, memory, and storage devices storing respective instructions that, when executed, cause the respective computing device, terminal device, and session server to perform operations comprising:
outputting, by the terminal device, connection information that identifies the terminal device;
detecting, by the computing device, the connection information that has been output by the terminal device;
in response to detecting the connection information, transmitting, by the computing device using its wireless communication interface and for receipt by the terminal device, a trust negotiation initiation message;
after the trust negotiation initiation message has been transmitted, performing a trust negotiation protocol between the computing device, the terminal device, and the facility server to establish a secure connection between the computing device and the terminal device;
receiving, by the terminal device using its wireless communication interface and from the computing device over the secure connection, a request to access one or more peripherals of the terminal device; and
in response to receiving the request to access the one or more peripherals of the terminal device, establishing, by the terminal device, a temporary pairing between the computing device and the one or more peripherals of the terminal device.

2. The computer system of claim 1, wherein the computing device, the terminal device, and the facility server are included in a local network of a facility, with the computing device being a mobile computing device having a wireless connection to the local network of the facility, and with the terminal device and the facility server each having respective wired connections to the local network.

3. The computer system of claim 2, wherein the one or more peripherals only have a wired connection to the terminal device and are not directly connected to the local network.

4. The computer system of claim 2, wherein the connection information that identifies the terminal device corresponds to an address of the terminal device on the local network.

5. The computer system of claim 1, wherein outputting the connection information that identifies the terminal device is performed by the terminal device when a user is actively logged into the terminal device, and in response to the launching of a pairing application on the terminal device.

6. The computer system of claim 1, wherein the connection information that identifies the terminal device is visually output by a display of the terminal device, and wherein detecting the connection information by the computing device comprises performing a scan of the connection information using scanning hardware of the computing device.

7. The computer system of claim 1, wherein the connection information that identifies the terminal device is output by the terminal device in a non-visual manner, and wherein detecting the connection information by the computing device comprises using non-visual detection hardware of the computing device to detect the connection information.

8. The computer system of claim 2, wherein the trust negotiation protocol between the computing device, the terminal device, and the facility server comprises:
in response to receiving the trust negotiation initiation message, transmitting, by the terminal device, a terminal device certificate for receipt by the computing device;
after receiving the terminal device certificate, validating the terminal device certificate, by the computing device and based on terminal device certificate validation data provided by a certificate authority of the facility server;
in response to validating the terminal device certificate, transmitting, by the computing device, a computing device certificate for receipt by the terminal device; and
after receiving the computing device certificate, validating the computing device certificate, by the terminal device and based on computing device certificate validation data provided by the certificate authority of the facility server.

9. The computer system of claim 1, wherein the request to access one or more peripherals of the terminal device is a request to access all peripherals of the terminal device.

10. The computer system of claim 1, wherein the request to access one or more peripherals of the terminal device is a request to access a particular one of the peripherals of the terminal device.

11. The computer system of claim 1, further comprising:
transmitting, by the computing device and for receipt by the terminal device over the secure connection, the request to access one or more peripherals of the terminal device, wherein the request to access the one or more peripherals is initiated by a transaction building and processing application running on the computing device.

12. The computer system of claim 1, further comprising:
determining, by the terminal device, whether the one or more peripherals of the terminal device are currently paired with another computing device, wherein the terminal device establishes the temporary pairing between the computing device and the one or more peripherals of the terminal device when the one or more peripherals of the terminal device are not currently paired.

13. The computer system of claim 1, further comprising:
determining, by the terminal device, whether a particular peripheral of the one or more peripherals of the terminal device is associated with a one-to-one pairing relationship or a one-to-many pairing relationship, wherein the terminal device establishes the temporary pairing between the computing device and the particular peripheral when the particular peripheral is associated with a one-to-many pairing relationship.

14. The computer system of claim 13, further comprising:
receiving, by the terminal device and from another computing device over another secure connection between the other computing device and the terminal device, another request to access the particular peripheral that is associated with the one-to-many pairing relationship; and
in response to receiving the other request, concurrently establishing another temporary pairing between the other computing device and the particular peripheral.

15. The computer system of claim 1, further comprising:
after establishing the temporary pairing between the computing device and the one or more peripherals of the terminal device, receiving, by the terminal device and from the computing device, a peripheral device command for a particular peripheral of the one or more peripherals of the terminal device; and
routing, by the terminal device, the peripheral device command to the particular peripheral.

16. The computer system of claim 1, further comprising:
after establishing the temporary pairing between the computing device and the one or more peripherals of the terminal device, receiving, by the terminal device and from the peripheral, peripheral data generated by the peripheral; and
routing, by the terminal device, the peripheral data to the computing device.

17. The computer system of claim 1, further comprising:
after establishing the temporary pairing between the computing device and the one or more peripherals of the terminal device, maintaining a record of the established pairing at a datastore of the terminal device.

18. The computer system of claim 1, further comprising:
receiving, by the terminal device and from a terminal device application, a request to reclaim the one or more peripherals of the terminal device; and
in response to receiving the request to reclaim the one or more peripherals of the terminal device, terminating, by the terminal device, the temporary pairing that has been established between the computing device and the one or more peripherals of the terminal device.

19. The computer system of claim 1, further comprising:
receiving, by the terminal device and from the computing device, a command to release the one or more peripherals of the terminal device; and
in response to receiving the command to release the one or more peripherals of the terminal device, terminating, by the terminal device, the temporary pairing that has been established between the computing device and the one or more peripherals of the terminal device.

20. The computer system of claim 1, further comprising:
determining, by the terminal device, that a timeout condition has occurred for a particular peripheral of the one or more peripherals of the terminal device; and
in response to determining that the timeout condition has occurred, terminating, by the terminal device, the temporary pairing that has been established between the computing device and the particular peripheral of the terminal device.
